(19) United States
(12) Patent Application Publication
(10) Pub. No.: US 2023/0220904 A1
(43) Pub. Date: Jul. 13, 2023

(54) JOINING ASSEMBLY

(71) Applicant: GRIPPLE LIMITED, Sheffield, South Yorkshire (GB)

(72) Inventors: James Hudson, Sheffield, South Yorkshire (GB); Thomas Reynolds, Sheffield, South Yorkshire (GB)

(21) Appl. No.: 18/008,638

(22) PCT Filed: Jun. 23, 2021
(86) PCT No.: PCT/IB2021/055532

§ 371 Date: Dec. 6, 2022

(30) Foreign Application Priority Data
Jul. 1, 2020 (GB) 2010059.0
Jun. 21, 2021 (GB) 2108872.9

(51) Int. Cl. F16G 11/10

(52) U.S. Cl. CPC F16G 11/108

(57) ABSTRACT

A joining assembly (12) comprises two joining devices (10). Each joining device (10) comprises a securing arrangement (46) for securing at least one article (14) to the joining devices (10). One of the joining devices (10) comprises a first attaching arrangement (30, 32), and the other of the joining devices (10) comprises a second attaching arrangement (30, 32). The first and second attaching arrangements can cooperate with each other to attach the joining devices (10) to each other.

This invention relates to joining assemblies. More particularly, but not exclusively, this invention relates to joining assemblies for joining elongate articles. This invention also relates to joining assemblies for joining the ends of elongate articles to each other. Embodiments of the invention relate to joining assemblies for joining wires, cables, wire ropes or the like.

In some agricultural situations, wire or other forms of elongate articles are used as fencing or trellises. Sometimes the wire can break or be accidentally cut. The ends of the wire then have to be joined together or replaced. It is preferred to join the ends, because replacing the wire can be expensive, but repairs can be difficult if the wire is under tension.

According to one aspect of this invention, there is provided a joining assembly comprising:

two joining devices;

each joining device comprising a securing arrangement for securing at least one article to the joining devices;

one of the joining devices comprising a first attaching arrangement, and the other of the joining devices comprising a second attaching arrangement;

wherein the first and second attaching arrangements can cooperate with each other to attach the joining devices to each other.

The joining assembly may be for joining two end regions of one or more elongate articles to each other. Each joining device may comprise a body. The first attaching arrangement may comprise a lug. The second attaching arrangement may comprise a receiving formation on the body.

The lug of the first attaching arrangement may be receivable by the receiving formation of the second attaching arrangement to attach the joining device to each other.

Each of the first and second attaching arrangements may comprise a respective lug on the body of each joining device. Each of the first and second attaching arrangements may comprise a respective receiving formation on the body of each joining device.

Each receiving formation may comprise a hole defined by the body of each joining device.

The joining devices may be attached to each other by the lug of the first attaching arrangement being received by the receiving formation of the second attaching arrangement, and the lug of the second attaching arrangement being received by the receiving formation of the first attaching arrangement.

According to another aspect of this invention, there is provided a joining assembly for joining two end regions of one or more elongate articles to each other, the joining assembly comprising:

first and second joining devices;

each joining device comprising a body and a securing arrangement for securing a respective end region to each joining device;

each joining device comprising an attaching arrangement comprising a lug on the body and a hole defined by the body;

wherein the lug of the first joining device is receivable by the hole defined by the body of the second joining device, and the lug of the second joining device is receivable by the hole defined by the body of the first joining device, thereby attaching the first and second joining devices to each other.

The elongate articles may be two separate articles, or two broken or cut ends of an elongate article. Alternatively, the first and second elongate articles may be two opposite ends of a single elongate article.

According to another aspect of this invention, there is provided a joining device for use as part of a joining assembly as described above, the joining device comprising:

a body;

a securing arrangement for securing an article to the joining device;

an attaching arrangement comprising a lug on the body and a hole defined by the body;

wherein the lug of the joining device is receivable by the hole defined by a body of a further joining device, and the lug of the further joining device is receivable by the hole defined by the body of the joining device, thereby attaching the joining devices to each other.

The, or each, attaching arrangement may comprise a receiving formation for receiving the lug. The receiving formation may comprise the hole defined by the body. The hole may be a through hole defined by the body.

The securing arrangement of the, or each, joining device may be provided within the body. The, or each, body may define an internal space to hold the securing arrangement. The, or each, body may define an opening through which the article can be inserted into the internal space.

The, or each, securing arrangement may comprise a path along which the article can extend. The, or each, securing arrangement may comprise a clamping member.

The clamping member may be urgeable into the path to engage the elongate article.

The, or each, securing arrangement may comprise a clamping formation against which the clamping member can clamp the elongate article. The, or each, clamping formation may comprise a clamping wall.

The, or each, securing arrangement may comprise a reaction formation for applying a reaction force against the clamping member when the clamping member clamps the elongate article.

The, or each, clamping wall may be a wall of the body. The, or each, reaction formation may be a wall of the body. The reaction formation may be arranged opposite the clamping formation.

The, or each, securing arrangement may comprise an urging member to urge the clamping member into the pathway. The, or each, urging member may be a resilient urging member, such as a spring.

The, or each, securing arrangement may comprise an engaging formation for engaging the urging member and allowing the urging member to urge the clamping member.

The, or each, securing arrangement may comprise an end stop to engage the elongate article on insertion of the elongate article into the body. Thus, the end stop may prevent further insertion of the elongate article into the body.

The, or each, securing arrangement may comprise a holding arrangement to provide the engaging formation. The holding arrangement may hold the urging member to allow the urging member to urge the clamping member into engagement with the elongate article.

The holding arrangement may comprise the end stop. The holding arrangement may be disposed within the main body.

The, or each, holding arrangement may comprise a holder for holding the urging member. The end stop may be spaced from the holder. One or more connecting members may extend between the end stop and the holder.

Two connecting members may extend between the end stop and the holder. A gap may be defined between the connecting members. The gap may provide a window through which a user can check whether the elongate article engages the end stop.

The body of the, or each, joining device may comprise a main part. The securing arrangement may be provided in the main part.

The, or each, first lug may be provided on the respective main part. The holding arrangement may be disposed within the main part.

The, or each, body may comprise a projecting formation. The, or each, projecting formation may be provided on the respective main part. The, or each, receiving formation may be provided on the respective projecting formation.

The, or each, main part may define a recess to receive the projecting formation of the other joining device. The lug may extend from the recess.

The main part of the, or each, joining device may define an aperture to receive the holding arrangement within the main part. The main part of the, or each, joining device may have an end face. The end face may define said aperture.

The, or each, end face has an edge extending around the aperture. The aperture may allow a user to see the inside of the body and look through the window.

The projecting formation may extend from the edge of the end face. The projecting formation may be substantially flat.

The end face may extend diagonally from the recess to the projecting formation. An obtuse angle may be defined between the end face and the projecting formation.

The recess may extend from a central region of the main part to the edge. The projecting formation may extend partially around the edge of the main part. The recess may be defined in the main part at a region opposite the projecting formation.

The, or each, main part may define an opening through which the elongate article can be received in the internal space. The, or each, projection may be provided on the respective main part opposite the opening.

The, or each, body may define a window to allow a user to view the position of the elongate article in the body. The window may be defined by the main part.

The, or each, lug may comprise a support portion and a head. The head may have a lip portion, wherein the lip portion extends beyond the support portion. The, or each, receiving formation may comprise a ledge. The lip portion may be configured to extend across the ledge of the other joining device to attach the joining devices to each other. The ledge may at least partially define the hole.

The, or each, hole may have wide and narrow regions, wherein the wide region allows the head to be inserted therethrough, and the narrow region can receive the support. The narrow region may be at least partially defined by the ledge.

The ledge may be elongate. The elongate ledge may extend alongside the narrow region.

When the support is received in the narrow region, the lug may engage the ledge, thereby locking the lug to the receiving formation. When the support is received in the narrow region, the lip portion may extend across the ledge, thereby locking the first and second joining devices to each other.

The wide region of the, or each, hole may be closer to the respective opening than the narrow region. Thus, when the lugs are received in the holes, the tension on the elongate articles may urge the first and second joining devices to move so that the support portions of the, or each, lug are received in the narrow regions of the, or each, hole, and the lip portions of the, or each, lug extend across the ledge.

The, or each, elongate ledge may be provided with a friction formation extending along the ledge. The, or each, lug may engage the friction formation of the other joining device. The, or each, friction formation may comprise a raised region on the ledge. The raised region may be a rib or a plurality of ribs.

When the, or each, lug is received by the hole of the other joining device, the, or each, lip portion may extend across the ledge to engage the, or each, friction formation.

The, or each, friction formation may engage the lug of the other joining device. The, or each, lip portion may engage the friction formation of the other joining device.

When so engaged, the, or each, friction formation may press on the lug of the other joining device, thereby applying a force on the lug to hold the two joining devices together. The, or each, friction formation may press on the lip portion of the other joining device, thereby applying a force on the lip portion.

At least one embodiment of the invention will now be described by way of example only, with reference to the accompanying drawings, in which:

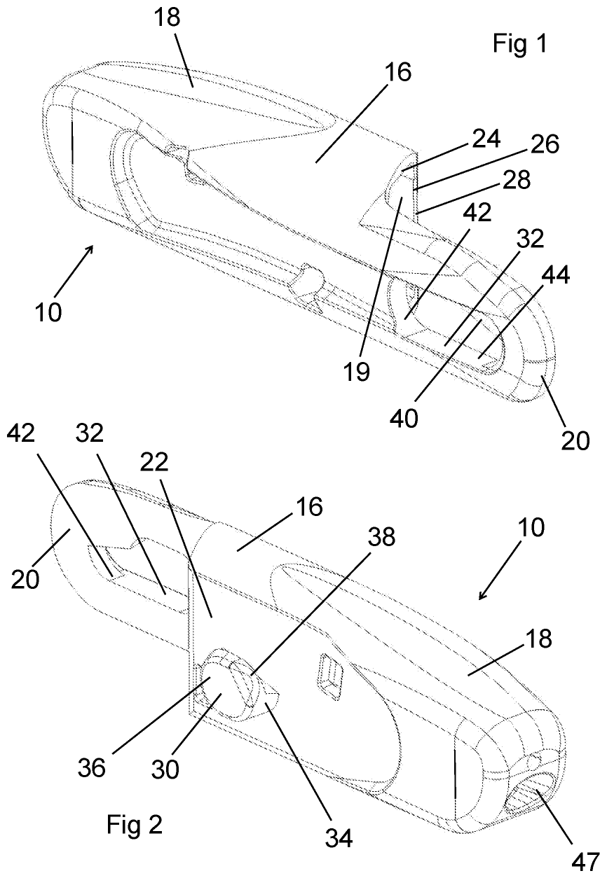

FIG. 1 is a perspective view from one direction of a joining device for use in a joining assembly;

FIG. 2 is a perspective view from the opposite direction of the joining device;

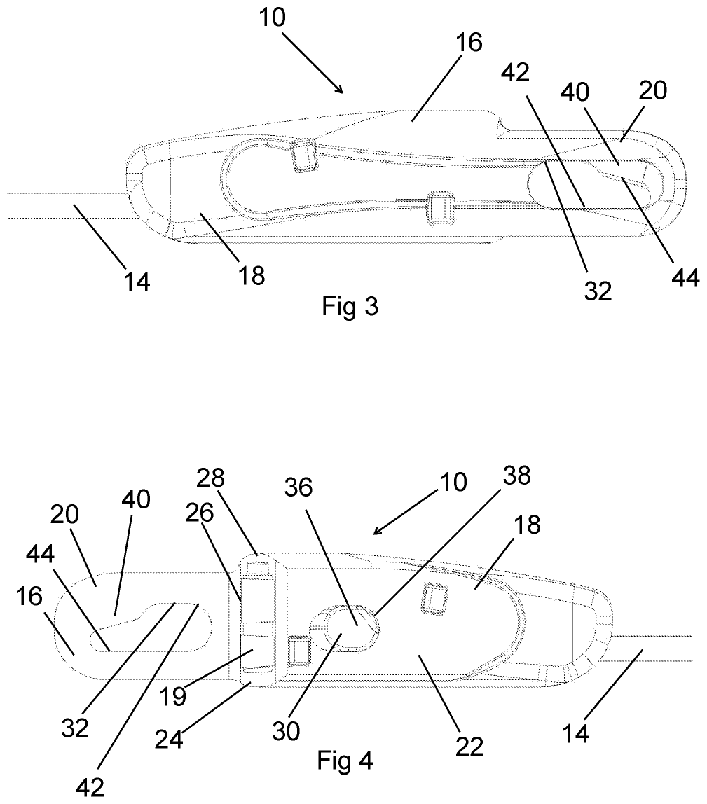

FIG. 3 is a top plan view of the joining device;

FIG. 4 is a bottom plan view of the joining device;

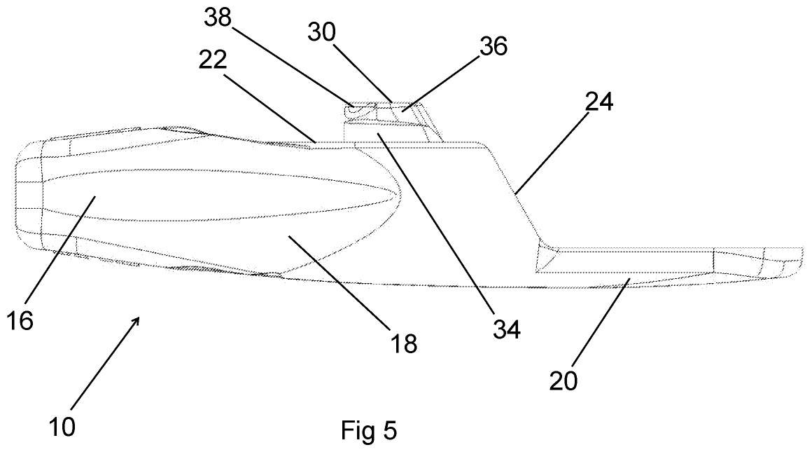

FIG. 5 is a side view of the joining device;

FIG. 6 is a sectional view of the joining device;

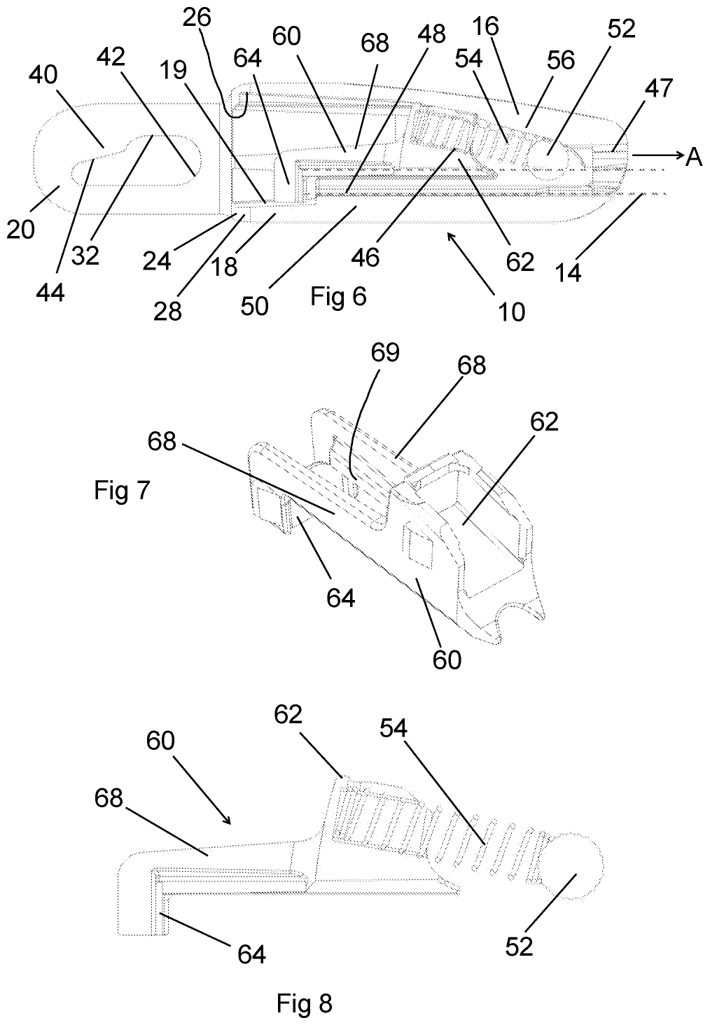

FIG. 7 is a perspective view of an insert for use in the joining device;

FIG. 8 is a sectional view of the insert, showing an urging member;

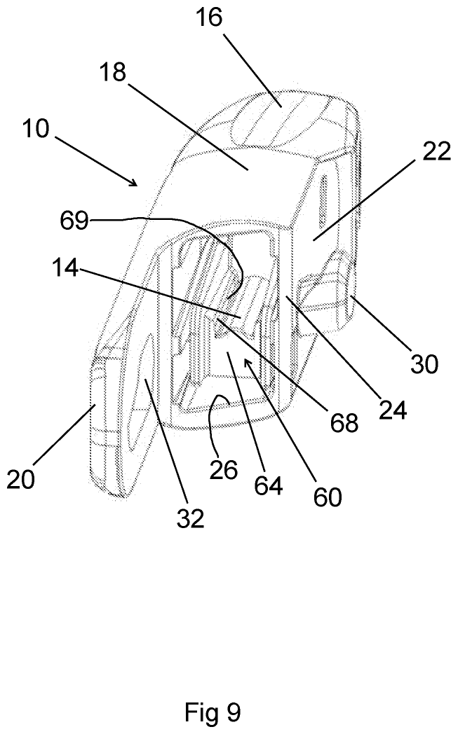

FIG. 9 shows an end view of the joining device;

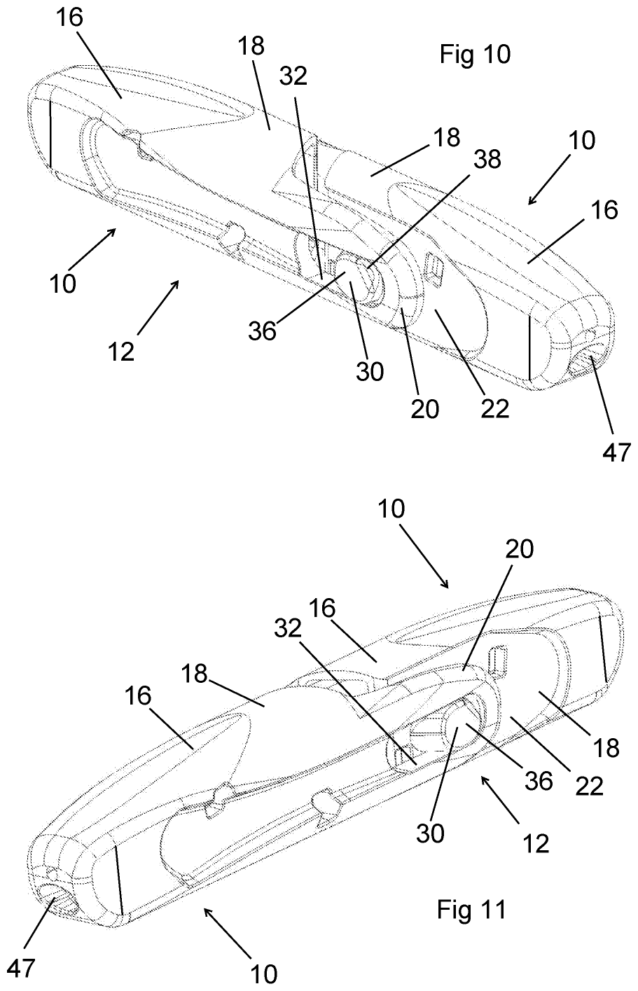

FIG. 10 is a perspective view from one direction of a joining assembly comprising first and second joining devices;

FIG. 11 is a perspective view from the opposite direction of the joining assembly;

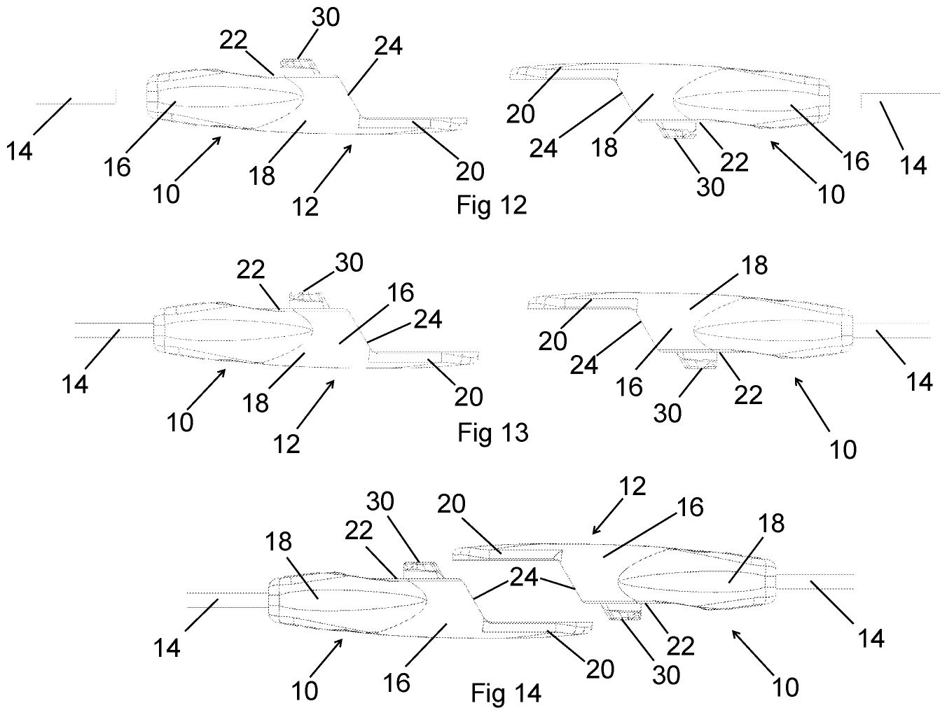

FIGS. 12 to 17 show the steps in attaching the first and second joining devices to each other to form the joining assembly;

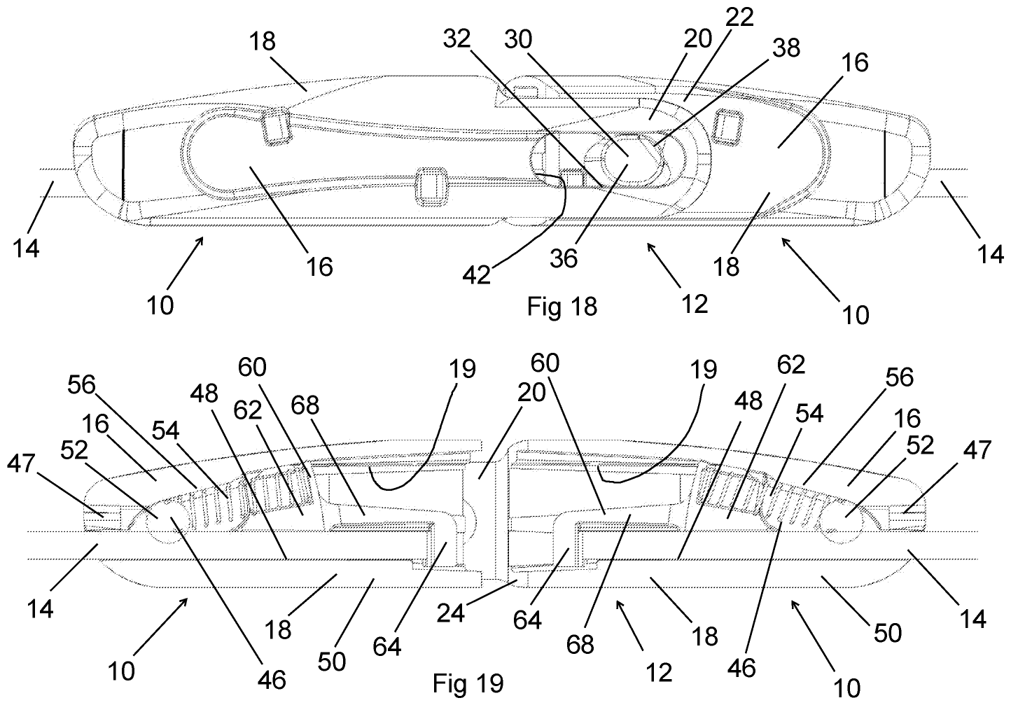

FIG. 18 is a side view of the joining assembly;

FIG. 19 is a sectional view of the joining assembly;

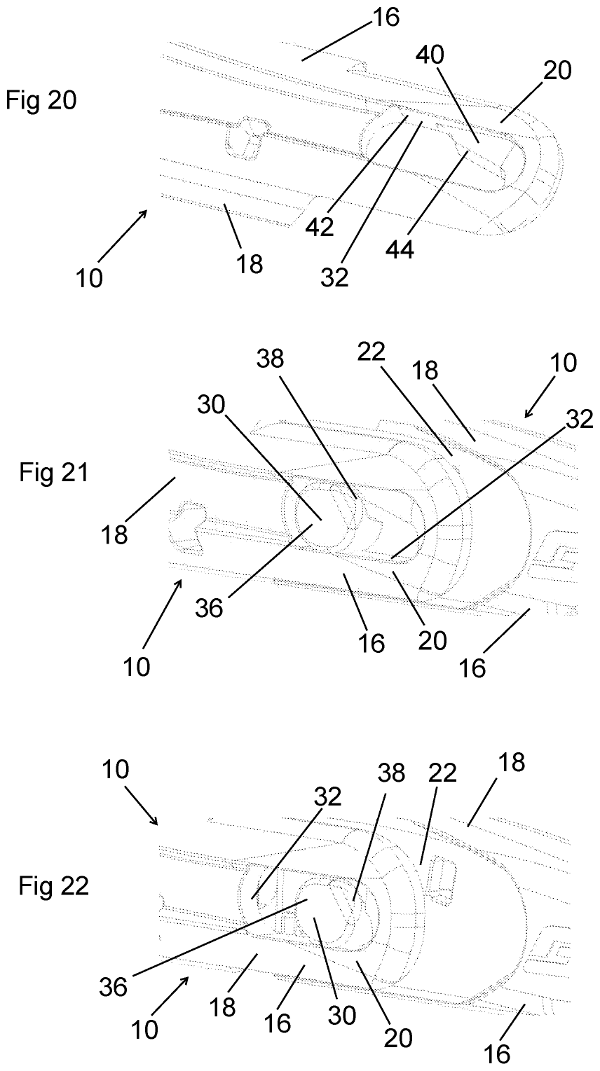

FIG. 20 is a close up view of a projecting formation of the first joining device;

FIG. 21 is a close up view showing a lug of one joining device being received by a receiving formation in the projecting formation of the other joining device;

FIG. 22 is a close up view showing the lug of one joining device extending across a ledge of the other joining device;

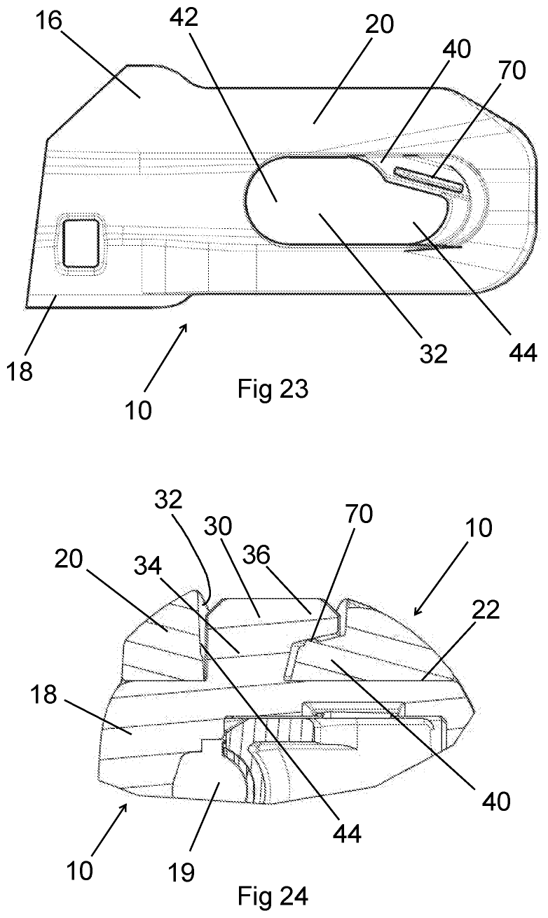

FIG. 23 is a plan view showing the projecting formation having a friction formation; and

FIG. 24 is a sectional view through the joining assembly.

FIGS. 1 to 4 show a joining device 10 for use in forming a joining assembly 12 for joining two elongate articles 14 to each other.

It will be appreciated that the elongate articles 14 could be separate articles, such as two wires, wire ropes, cables, or the like. Alternatively, the elongate articles 14 could be respective portions of a single elongate article that has been broken or cut. Alternatively, the elongate articles 14 may be respective end regions of the same elongate article.

The joining assembly 12 is shown in FIGS. 10 to 19 and comprises first and second of the joining devices 10 attached to each other. The first and second joining devices 10 are identical to each other.

Each joining device 10 comprises a body 16 having a main part 18 and a substantially flat projecting formation 20. The main part 18 defines an internal space 19 in which a securing arrangement 46 is provided to secure the elongate article 14 to the joining device 10. The securing arrangement 46 is described in detail below.

Each main part 18 defines a recess 22 to receive the projecting formation 20 of the other joining device 10. Each main part 18 has an end face 24 extending diagonally from the recess 22 to the projecting formation 20.

An obtuse angle is defined between the end face 24 and the projecting formation 20. The end face 24 defines an aperture 26 to provide access to the internal space 19.

The end face 24 has an edge 28 around the aperture 26. The substantially flat projecting formation 20 extends from a region of the edge 28. The recess 22 is defined in the main part 18 opposite the projecting formation 20.

The first joining device 10 comprises a first attaching arrangement. The second joining device 10 comprises a second attaching arrangement. The first and second attaching arrangements cooperate with each other to attach the first joining device 10 to the second joining device 10.

Each of the first and second attaching arrangements comprises a lug 30 on the main part 18 of the body 16 and a receiving formation in the form of a through hole 32 defined by the projecting formation 20. The lug 30 extends from the recess 22.

Each lug 30 comprises a support portion 34 and a head 36. The support portion 34 connects the head 36 to the main part 18 of the body 16. The head 36 has a lip portion 38, which extends beyond the support portion 34.

Each receiving formation comprises an elongate ledge 40 extending across the hole 32. Each hole 32 has wide and narrow regions 42, 44. The elongate ledge 40 partially defines the narrow region 44.

The wide region 42 of the hole 32 of each of the joining devices 10 allows the head 36 of the lug 30 of the other joining device 10 to be inserted therethrough.

Each narrow region 44 can then receive the support portion 34 of the other joining device 10. As a result, each lip portion 38 extends across the ledge 40 of the other joining device 10, thereby preventing the lug 30 from being removed from the hole 32.

When the lug 30 of each joining device 10 is received by the hole 32 of the other joining device 10, and the support portions 34 received in the narrow regions 44, both lip portions 38 extend over the ledges 40. In this position of the lugs 30, the first and second joining devices 10 are locked to each other.

Each of the first and second joining devices 10 comprises the securing arrangement 46 for securing an end region of respective elongate articles 14 to each joining device 10.

In order to secure the elongate articles 14 to the first and second joining devices 10, each joining device 10 comprises the securing arrangement 46 in the internal space 19 defined by the main part 18 of the body 16.

The main part 18 defines an opening 47 at an end of the main part 18 opposite the projecting formation 20. The elongate articles can be inserted into the spaces 19 through the openings 47.

Each securing arrangement 46 has a path 48 along which the end region of the elongate article 14 can extend. The path 48 is provided adjacent a clamping formation in the form of a clamping wall 50. The clamping wall 50 is a wall of the main part 18.

A clamping member 52 and an urging member 54 are provided. The clamping member 52 is in the form of a roller, but it will be appreciated that the clamping member 52 could be any other type of clamping member 52, such as a wedge.

The urging member 54 is in the form of a spring, and urges the clamping member 52 into the path 48 to clamp the elongate article 14 against the clamping wall 50.

The urging member 54 extends along a reaction formation in the form of a reaction wall 56. The reaction wall 56 is also a wall of the main part 18.

The reaction wall 56 and the clamping wall 50 converge towards each other, thereby providing a narrowing gap therebetween.

Each securing arrangement 46 comprises an engaging formation in the form of a holding arrangement 60 for holding the urging member 54. The holding arrangement 60 holds the urging member 54 so that it can urge the clamping member 52 into engagement with the elongate article 14.

The holding arrangement 60 is shown most clearly in FIGS. 7 and 8. The holding arrangement 60 is inserted into the space 19 in the main part 18 via the aperture 26.

Each holding arrangement 60 comprises a substantially rectangular holder 62 for holding an end region of the urging member 54. The holding arrangement 60 further includes an end stop 64 spaced from the holder 62.

The end stop 64 engages the end of the elongate article 14 on insertion of the elongate article into the main part 18. Thus, the end stop 64 prevents further insertion of the elongate article 14 into the body 16.

Two connecting members 68 extend between the end stop 64 and the holder 62. A gap is defined between the connecting members 68. The gap provides a window 69 through which a user can check whether the elongate article 14 engages the end stop 64.

Referring to FIG. 9, the aperture 26 allows a user to view the inside of the main part 18 and look through the window 69.

The urging member 54 urges the clamping member 52 along the reaction wall 56 towards the clamping wall 50. The clamping member 52 is urged against the end region of the elongate article 14 between the reaction wall 56 and the clamping wall 50.

Clamping of the elongate article 14 occurs by the clamping member 52 being wedged between the reaction wall 56 and the elongate article 14.

In the position shown, for example in FIG. 6, tension applied to the elongate article 14 (shown in broken lines) in the direction indicated by the arrow A pulls the clamping member 52 further into the narrowing gap, thereby increasing the clamping force on the elongate article 14.

Thus, the end region of the elongate article 14 and the clamping member 52 are clamped between the reaction wall 56 and the clamping wall 50.

Referring to FIGS. 12 to 17, the joining assembly 12 is shown being assembled. FIGS. 12 and 13 show an end region of each of the elongate articles 14 inserted through the opening in a respective one of the main parts 18. When so inserted, the end regions are clamped by the securing arrangements 46 in the main parts 18.

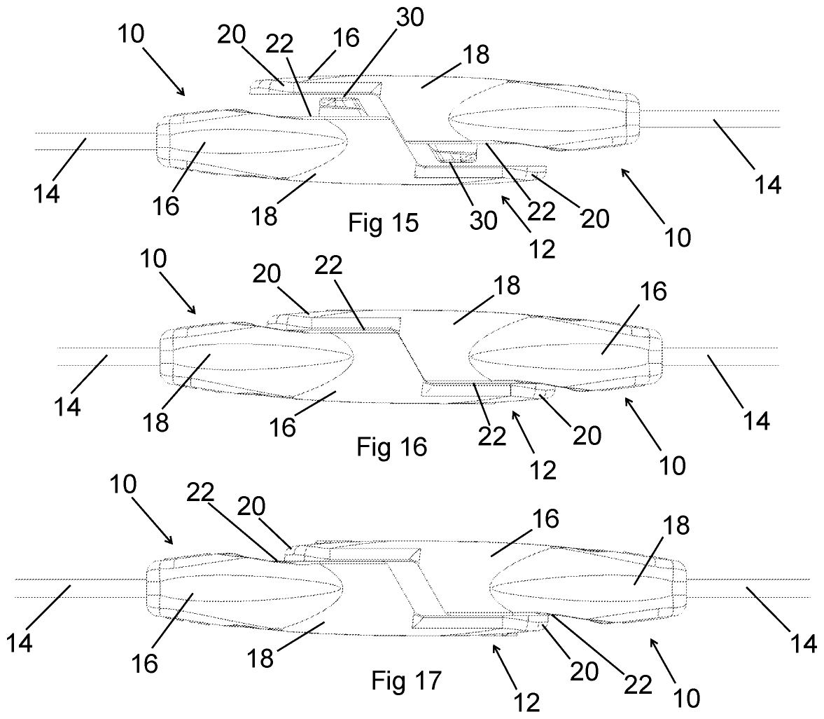

FIGS. 14 and 15 show the first and second joining devices 10 being brought together so that the projecting formation 20 of each joining device 10 overlaps the main part 18 of the other joining device 10.

The joining devices 10 can be manipulated so that, as shown in FIG. 16, the lug 30 of the first joining device 10 is received by the hole 32 defined by the projecting formation 20 of the second joining device 10, and the lug 30 of the second joining device 10 is received by the hole 32 defined by the projecting formation 20 of the first joining device 10.

In the position shown in FIG. 16, the lugs 30 are disposed in the respective holes 32 so that the support portion 34 extends through the wide regions 42 of the holes 32. The wide region 42 of each hole 32 is closer to the main part 18 of the respective joining device 10 than the narrow region 44.

Thus, referring to FIG. 17, when the lugs 30 are received in the holes 32, tension in the elongate articles 14 pulls the first and second joining devices 10.

As a result, the support portions 34 of each lug 30 are moved into the narrow regions 44 of each hole 32, and the lip portions 38 of each lug 30 extend across the ledge 40. This has the effect of preventing the lugs 30 from moving out of the holes 32 and causing the joining devices 10 to be detached from each other.

The embodiment of the joining assembly 12 described herein allows two cut ends of an elongate article 14 (such as a fence or trellis wire) to be joined together to effectively repairing the elongate article 14.

The joining assembly 12 provides the advantage that it provides two large members on the ends of the elongate articles 14, thereby allowing a person repairing the cut elongate article 14 to grip the cut end regions and pull them together.

Various modifications can be made without departing from the scope of the invention. For example, the elongate ledge 40 of each joining device 10 may be provided with a friction formation in the form of a rib 70 extending along the ledge 40. FIGS. 23 and 24 show one of the joining devices 10 that includes the rib 70.

FIG. 23 is a top view showing the projecting formation 20 and the rib 70 on the ledge 40. FIG. 24 is a sectional view through the joining assembly 12, showing the interaction between the lug 30 and the rib 70 on the ledge 40.

Specifically, FIG. 24 shows the engagement of the lip portion 38 with the rib 70. The lip portion 38 extends from the support portion 34 across the ledge 40, thereby engaging the rib 70, as shown in FIG. 24.

When the lug 30 of each joining device 10 is received by the hole 32 of the other joining device 10, and the support portions 34 received in the narrow regions 44, both lip portions 38 extend over the ledges 40. In this position, the lip portion 38 of each joining device 10 engages the rib 70 of the other joining device 10.

When so engaged, each rib 70 presses on the lip portion 38 of the other joining device, thereby applying a force on the lip portion to hold the two joining devices 10 together. As a result, the two joining devices allow a user, e.g. an installer, to apply appropriate tension to the elongate articles 14.

1. A joining assembly comprising:
two joining devices;
each joining device comprising a clamp for securing at least one article to the joining devices;
one of the joining devices comprising a first attachment, and the other of the joining devices comprising a second attachment;
wherein the first and second attachments can cooperate with each other to attach the joining devices to each other.

2. A joining assembly according to claim 1, wherein each joining device comprises a body, the first attachment comprises a lug on the body, and the second attachment comprises a receiver on the body, wherein the lug of the first attachment is receivable by the receiver of the second attachment to attach the joining device to each other.

3. (canceled)

4. A joining assembly according to claim 2, wherein each of the first and second attachments comprises a lug on the body of each joining device, and each of the first and second attachments comprises one of the receivers on the body of each joining device, the receiver of each joining device being arranged to receive the lug of the other joining device.

5. A joining assembly according to claim 4, wherein the joining devices are attached to each other by the lug of the first attachment being received by the receiver of the second attachment, and by the lug of the second attachment being received by the receiver of the first attachment.

6. A joining assembly according to claim 2, wherein each receiver comprises a hole defined by the body of the respective joining device, and wherein each lug comprises a support portion and a head, the head having a lip portion, the lip portion extending beyond the support portion.

7. A joining assembly according to claim 6, wherein the hole has wide and narrow regions; and wherein the wide region allows the head to be inserted therethrough, and the narrow region can receive the support.

8. A joining assembly according to claim 7 wherein each receiver comprises a ledge at least partially defining the narrow region, and the lip portion is configured to extend across the ledge of the other joining device when the support is received in the narrow region, thereby attaching the joining devices to each other.

9. A joining assembly according to claim 8, wherein each ledge is provided with a friction formation extending along the ledge, and wherein each lug engages the friction formation of the other joining device, whereby when so engaged, each friction formation presses on the lug of the other joining device, thereby applying a force on the lug to hold the two joining devices together.

10. A joining assembly according to claim 9, wherein when each lug is received by the hole of the other joining device, each lip portion extends across the ledge to engage the friction formation.

11. (canceled)

12. A joining assembly according to claim 1, wherein each clamp comprises a path along which the elongate article can extend, and each clamp comprises a clamp member and an urger to urge the clamp member along the respective path to engage the elongate article.

13. A joining assembly according to claim 12, wherein each clamp comprises a clamping wall against which the clamp can clamp the elongate article, and each clamp comprises a reaction wall for applying a reaction force on the clamp when the clamp member clamps the elongate article against the clamping wall.

14. A joining assembly according to claim 13, wherein each clamp comprises a holder to hold the urger to enable the urger to urge the clamp member into engagement with the elongate article.

15. A joining assembly according to claim 14, wherein each holder is disposed within the respective body, an end stop is connected to the holder, the end stop engaging the elongate article on insertion of the elongate article into the body.

16. (canceled)

17. A joining assembly according to claim 15, wherein each end stop is spaced from the respective holder, and wherein one or more connectors extend between the end stop and the holder.

18. A joining assembly according to claim 17, wherein two connectors extend between the end stop and the holder, and a gap is defined between the connectors, the gap providing a window through which a user can check whether the elongate article engages the end stop.

19. A joining assembly according to claim 12, wherein each urger comprises a spring.

20. A joining assembly according to claim 2, wherein the body of each joining device comprises a main part and a projecting formation, each projecting formation being provided on the respective main part.

21. A joining assembly according to claim 20, wherein each first lug is provided on the respective main part, and wherein each receiver is provided on the respective projecting formation.

22. A joining assembly according to claim 20, wherein the main part of each joining device defines an aperture to receive the holder within the main part, each end face having an edge extending around the aperture.

23. (canceled)

24. (canceled)

25. A joining device for use as part of a joining assembly as claimed in claim 1, the joining device comprising:
a body;
a clamp for securing an article to the joining device;
an attachment comprising a lug on the body and a hole defined by the body;
wherein the lug of the joining device is receivable by the hole defined by a body of a further joining device, and the lug of the further joining device is receivable by the hole defined by the body of the joining device, thereby attaching the joining devices to each other.
